(19) United States
(12) Patent Application Publication
(10) Pub. No.: US 2012/0036540 A1
(43) Pub. Date: Feb. 9, 2012

(54) ELECTRONIC DEVICE AND METHOD FOR SEARCHING PRODUCT INFORMATION IN TV PROGRAMS WITH PRODUCT PLACEMENTS

(75) Inventors: CHUNG-I LEE, Tu-Cheng (TW); CHIEN-FA YEH, Tu-Cheng (TW); SHAN-CHUAN JENG, Tu-Cheng (TW); CHENG-FENG TSAI, Tu-Cheng (TW); TSUNG-HSIN YEN, Tu-Cheng (TW); YU-FENG CHIEN, Tu-Cheng (TW); HO-I SUN, Tu-Cheng (TW)

(73) Assignee: HON HAI PRECISION INDUSTRY CO., LTD., Tu-Cheng (TW)

(21) Appl. No.: 13/115,071

(22) Filed: May 24, 2011

(30) Foreign Application Priority Data
Aug. 9, 2010 (TW) 99126406

(51) Int. Cl. H04N 5/445

(52) U.S. Cl. 725/60

(57) ABSTRACT

A method searches product information in TV programs with product placements using an electronic device. The electronic device defines keywords and appearance times of products presented on a TV program. During the TV program broadcasts, the electronic device displays the keywords of the presented products on a display device according to the predetermined appearance times. A product is selected from the presented products after any of the keyword presented on the TV program is tapped. The electronic device uses a search engine to search for related information of the selected product according to the tapped keyword, and displays the searched information on the display device for users to browse.

### BACKGROUND

1. Technical Field

Embodiments of the present disclosure generally relate to advertisement displaying devices and methods, particularly to an electronic device and method for searching product information in TV programs with product placements.

2. Description of Related Art

Product placement is increasingly becoming a more popular form of advertising in today's media environment, especially with the growing use of digital recording devices such as TIVO and DVR that allow viewers to skip commercials. While there are numerous advantages to this marketing strategy, one major disadvantage is that the viewers have no concrete information on what the product is or even where to purchase it. This lack of information may inhibit sales growth, keeping this kind of advertising from being a better investment of advertising dollars.

### BRIEF DESCRIPTION OF THE DRAWINGS

FIG. 1 is a block diagram of one embodiment of an electronic device including an information searching unit.

FIG. 2 is a block diagram of one embodiment of function modules of the information searching unit of FIG. 1.

FIG. 3 is a flowchart illustrating one embodiment of a method for searching product information in TV programs with product placements.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

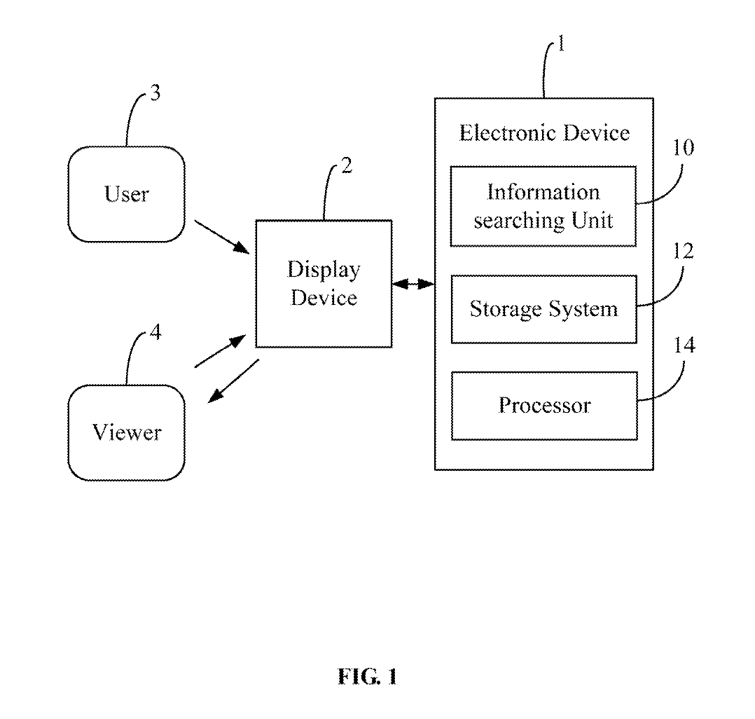

FIG. 1 is a block diagram of one embodiment of an electronic device 1 including an information searching unit 10. In the embodiment, functions of the information searching unit 10 are implemented by the electronic device 1. The information searching unit 10 can search related information of products presented in a TV program from networks, and display the searched information on a display device 2 that is electronically connected to the electronic device 1 via a wired or wireless connection. In one embodiment, the products may be cars, watches, or clothes. The searched information of the products may include web page and/or a website address. The TV program may be a movie, a TV series, or any other entertainment show.

In one embodiment, the electronic device 1 may be a computer, a TV, a portable electronic device, or any other electronic device that includes a storage system 12 and at least one processor 14.

The information searching unit 10 is configured to receive keywords and appearance times of products presented on a TV program, and display the keywords of the presented products on the display device 2 concurrently with the TV program according to the appearance times. When a viewer 4 taps any keyword displayed on the TV program (e.g., using a finger or a stylus) to select a presented product, the information searching unit 10 can load the keyword of the selected product in a search engine to search related information of the selected product, and displays the searched information on the display device 2. The search engine can be predetermined or user configurable as will be shown below.

The display device 2 is used for receiving a selection operation of the keyword from the viewer 4, and displaying the searched information of the selected product. In the embodiment, the display device 2 is a touch-sensitive display or a 3D display, and can receive an input operation of the viewer 4 using a finger or a stylus pen. For example, if the electronic device 1 is a TV, the viewer 4 can use a remote control to operate (i.e., select a product) the electronic device 1.

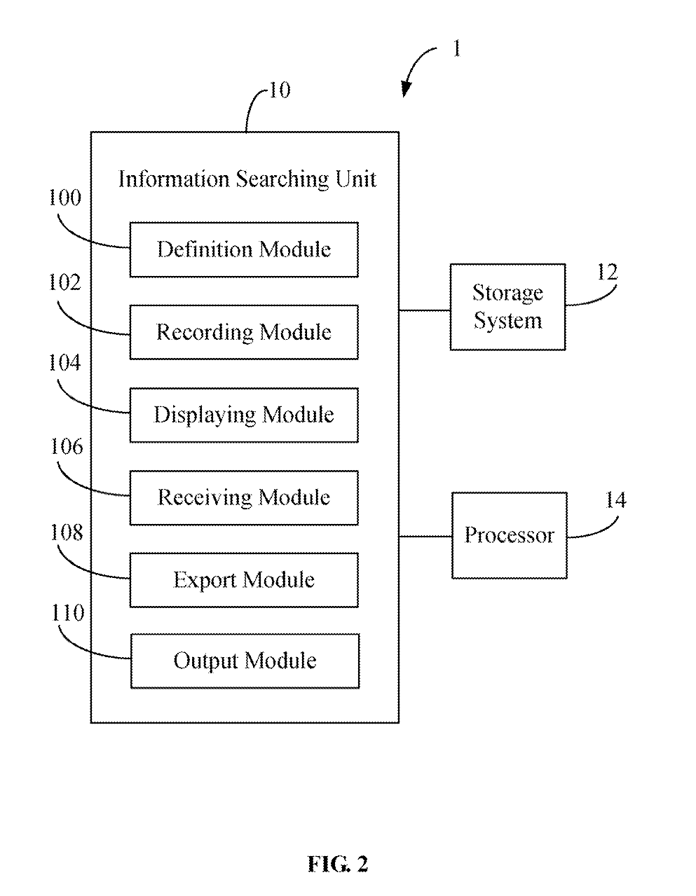

FIG. 2 is a block diagram of one embodiment of function modules of the information searching unit 10 of FIG. 1. In one embodiment, the information searching unit 10 includes a definition module 100, a recording module 102, a displaying module 104, a receiving module 106, a searching module 108, and an output module 110. Each of the modules 100-110 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

Before the display device 2 broadcasts a TV program, the definition module 100 defines keywords and appearance times of the presented products on the TV program. In the embodiment, each of the appearance times includes a start time and an end time of the keywords to be presented on the TV program. For example, if a skirt worn by a woman is presented on a TV series from 9:00 to 9:02, the definition module 102 can define the keyword of the skirt as “ABC skirt,” define the start time of the keyword “ABC skirt” as 9:00, and define the end time of the keyword “ABC skirt” as 9:02.

The recording module 104 records the keywords and the appearance times of the presented products in an image file or a movie file that is compatible with the TV program. In one embodiment, the movie file may be in a MPEG-2, MPEG-4, or an AVC format.

When the display device 2 broadcasts the TV program, the displaying module 102 displays the keywords of the presented products on the display device 2 concurrently with the TV program according to the appearance times.

The receiving module 106 receives a selection operation of a presented product from the viewer 4. For one example, if the display device 2 is a touch-sensitive display, the viewer 4 may use a finger or a stylus to tap the keyword of the presented product to select the product, and then the receiving module 106 receives the selection operation. For another example, the selection of the keywords is a taping of a mouse, or a depression of a button of a remote control.

The searching module 108 loads the keyword of the selected product in a search engine, and searches related information of the selected product from networks using the search engine. In one embodiment, the search engine may be predetermined such as use of an Internet search engine or other searching tools, and the related information may be web pages, and/or website addresses. The search engine may be predetermined or user-defined in other embodiments.

The output module 110 displays the searched information of the selected product on the display device 2, so the viewer 4 can browse the searched information from the display device 2.

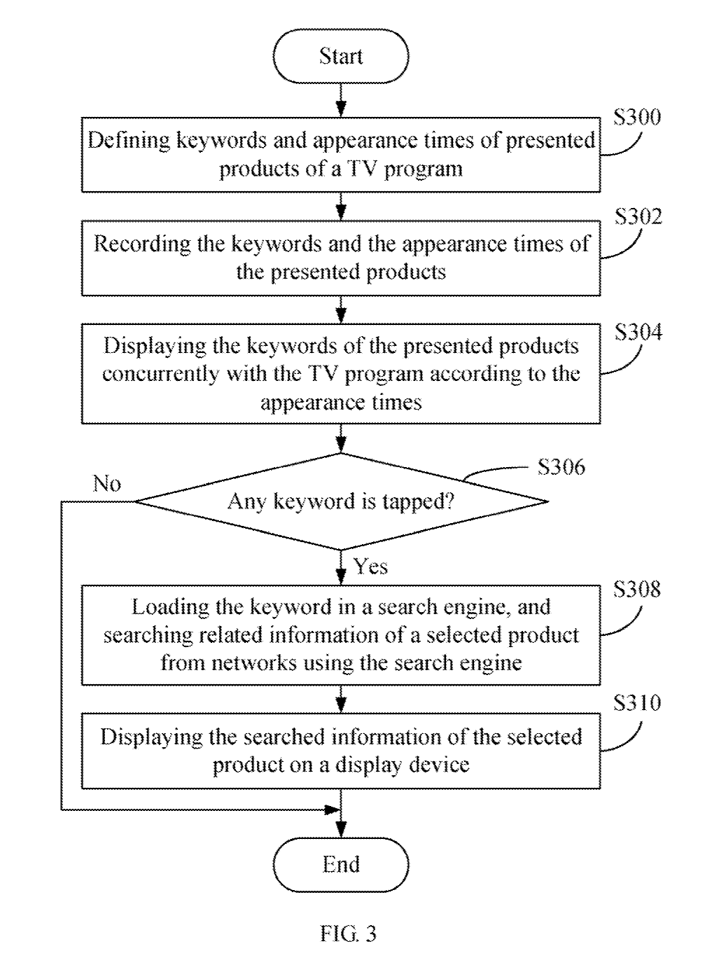

FIG. 3 is a flowchart illustrating one embodiment of a method for searching product information in TV programs with product placements. Depending on the embodiment, additional blocks may be added, others removed, and the ordering of the blocks may be changed.

In block S300, the definition module 100 defines keywords and appearance times of products presented on the TV program. In the embodiment, each of the appearance times includes a start time and an end time of the keywords to be presented on the TV program. The TV program may be a movie, a TV series, or any other entertainment shown.

In block S302, the recording module 104 records the keywords and the appearance times of the presented products in an image file or a movie file that is compatible with the TV program. The movie file may be in a MPEG-2, MPEG-4, or an AVC format.

In block S304, the displaying module 102 displays the keywords of the presented products on the display device 2 concurrently with the TV program according to the appearance times.

In block S306, the receiving module 106 determines whether any keyword presented on the TV program has been tapped by the viewer 4. In one example, the viewer 4 may touch the display device 2 with a finger or a stylus to select the keyword of a presented product, to select the presented product. If any keyword has been tapped, block S308 is implemented. If no keyword is tapped, the flow ends.

In block S308, the searching module 108 loads the keyword of the selected product in a search engine, and searches related information of the selected product from networks using the search engine. As mentioned above, the search engine may be predetermined such as use of an Internet search engine or other searching tools, and the related information of the selected product may be web pages and/or website addresses.

In block S310, the output module 110 displays the searched information of the selected product on the display device 2, so that the viewer 4 can browse the searched information of the selected product from the display device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for searching product information in TV programs with product placements using an electronic device, the method comprising:
defining keywords and appearance times of products presented on a TV program;
displaying the keywords of the presented products on a display device concurrently with the TV program according to the appearance times, the display device electronically connected to the electronic device during the TV program;
receiving a selection operation for a product selected from the presented products displayed on a display device, the selection operation according to selection of a keyword of the product;
searching related information of the selected product according to the keyword of the selected product using a search engine; and
displaying the searched information of the selected product on the display device.

2. The method as described in claim 1, further comprising:
recording the keywords and the appearance times of the presented products in an image file or a movie file that is compatible with the TV program.

3. The method as described in claim 2, wherein the movie file is in a MPEG-2, MPEG-4, or an AVC format.

4. The method as described in claim 1, wherein the TV program is a movie, a TV series, or an entertainment show.

5. The method as described in claim 1, wherein each of the appearance times comprises a start time and an end time of the keywords to be presented on the TV program.

6. An electronic device, comprising:
at least one processor;
a storage system; and
one or more modules that are stored in the storage system and executed by the at least one processor, the one or more modules comprising instructions:
to define keywords and appearance times of products presented on a TV program;
to display the keywords of the presented products on a display device concurrently with the TV program according to the appearance times, the display device electronically connected to the electronic device during the TV program;
to receive a selection operation for a product selected from the presented products displayed on a display device, the selection operation according to selection of a keyword of the product;
to search related information of the selected product according to the keyword of the selected product using a search engine; and
to display the searched information of the selected product on the display device.

7. The electronic device as described in claim 6, wherein the keywords and the appearance times related to the presented products are recorded in an image file or a movie file that is compatible with the TV program.

8. The electronic device as described in claim 7, wherein the movie file is in a MPEG-2, MPEG-4, or an AVC format.

9. The electronic device as described in claim 6, wherein the TV program is a movie, a TV series, or an entertainment shown.

10. The electronic device as described in claim 6, wherein each of the appearance times comprises a start time and an end time of the keywords to be presented on the TV program.

11. A non-transitory storage medium having stored thereon instructions that, when executed by a processor of an electronic device, causes the processor to perform a method for searching product information in TV programs with product placements, the method comprising:
defining keywords and appearance times of products presented on a TV program;
displaying the keywords of the presented products on a display device concurrently with the TV program according to the appearance times, the display device electronically connected to the electronic device during the TV program;
receiving a selection operation for a product selected from the presented products displayed on a display device, the selection operation according to selection of a keyword of the product;
searching related information of the selected product according to the keyword of the selected product using a search engine; and
displaying the searched information of the selected product on the display device.

12. The storage medium as described in claim 11, wherein the method further comprises:
recording the keywords and the appearance times of the presented products in an image file or a movie file that is compatible with the TV program.

13. The storage medium as described in claim 12, wherein the movie file is in a MPEG-2, MPEG-4, or an AVC format.

14. The storage medium as described in claim 11, wherein each of the appearance times comprises a start time and an end time of the keywords to be presented on the TV program.
